(19) United States
(12) Patent Application Publication
(10) Pub. No.: US 2018/0097280 A1
(43) Pub. Date: Apr. 5, 2018

(54) BLUETOOTH CONTROL UNIT

(71) Applicant: Dr. Ing. h.c. F. Porsche Aktiengesellschaft, Stuttgart (DE)

(72) Inventor: Joachim Graner, Metzingen (DE)

(21) Appl. No.: 15/688,904

(22) Filed: Aug. 29, 2017

(30) Foreign Application Priority Data
Oct. 5, 2016 (DE) 102016118892.1

(51) Int. Cl. H01Q 1/32; H04W 84/18; B62D 15/02; G01S 19/51; G05D 1/00; G08G 1/16

(52) U.S. Cl. CPC H01Q 1/3283; H04W 84/18; G08G 1/163; G01S 19/51; G05D 1/0088; B62D 15/0285

(57) ABSTRACT

A Bluetooth control unit for a vehicle includes a microcontroller; a transceiver connected to the microcontroller, the transceiver having an RF terminal for connection to an antenna; a plurality of antenna terminals; and a passive circuit. The passive circuit connects the RF terminal of the transceiver and the plurality of antenna terminals in a passive manner.

### CROSS REFERENCE TO RELATED APPLICATIONS

This application claims benefit to German Patent Application No. DE 10 2016 118 892.1, filed Oct. 5, 2016, which is hereby incorporated by reference herein.

### FIELD

The present invention relates to a Bluetooth control unit for a vehicle, having a microcontroller and a transceiver connected to the microcontroller, the transceiver having a terminal for connection to an antenna. The invention also relates to a receiving apparatus for receiving Bluetooth signals for a vehicle, having an above-mentioned Bluetooth control unit. The invention also relates to a remotely controllable autonomous parking apparatus having a control device for carrying out an autonomous parking operation and an above-mentioned receiving apparatus which is connected to the control device. The invention likewise relates to a vehicle having an above-mentioned receiving apparatus. Finally, the invention relates to a vehicle having an above-mentioned remotely controllable autonomous parking apparatus.

### BACKGROUND

Radio connections are used for various functions in vehicles in order to make these functions remotely controllable and to provide a user with the greatest possible degree of comfort. For example, it has already been known practice for a relatively long time to configure vehicles with a central locking system which can be actuated using a radio remote control. In this case, the radio remote control is usually integrated in a vehicle key.

In addition, for a “remotely controlled parking” function, also referred to as autonomous parking, with the aid of a smartphone for example, a Bluetooth low energy connection is set up between the vehicle and the smartphone. The vehicle is woken up and started and the parking operation is controlled with the aid of the Bluetooth connection. Since the control of the parking operation is a safety-critical element in which the vehicle is moved without a driver, a very good, interruption-free connection must exist between the smartphone and the vehicle. This requires good field coverage around the vehicle. For example, the interruption-free connection must be ensured in a radius of up to 10 m around the vehicle.

If this connection between the vehicle and the smartphone is not ensured, the vehicle stops automatically for safety reasons. On account of the safety-critical function, latency times of less than 120 ms must be complied with in the case of the Bluetooth connection in order to ensure an emergency stop of the vehicle at a speed of up to 4 km/h during “remotely controlled parking”. Even brief interruptions in the Bluetooth connection between the vehicle and the smartphone are therefore unacceptable.

In the prior art, it is known practice to fit an antenna for the Bluetooth connection, for example in the form of a roof antenna, to the vehicle roof, typically in a rear region of the vehicle roof, thus making it possible to achieve uniform field coverage around the vehicle. This position is advantageous from the point of view of antenna technology since the requirements and the field coverage around the vehicle can be achieved well with an antenna in this position. However, on account of the vehicle dimensions, the field coverage is reduced by the dimensions of the vehicle in the respective direction. If the driver approaches the vehicle from the front, the distance to the antenna is thus, in practice, up to four meters or more greater than the distance to the front end of the vehicle.

In addition, it is not possible to accordingly fit the antenna in all vehicles. For example, it is not possible to fit the antenna to the roof in the case of convertibles.

Another disadvantage of the roof antenna is that it visibly projects upward from the vehicle roof. This is disadvantageous for aerodynamic reasons. In addition, such a roof antenna is esthetically not acceptable for many drivers.

In addition, the roof antennas are often in the form of vertically polarized antennas which are sensitive to different holding positions of the smartphone, for example.

In this context, EP 2 295 281 A1 discloses a driver assistance device which can be used by the driver of a motor vehicle to detect a hazardous situation during an operation of autonomously parking the motor vehicle. A driver assistance device is provided, the control device of which is designed to output control signals to a drive or steering apparatus of the motor vehicle, which control signals cause an autonomous parking operation to be carried out. The control device is also designed to receive commands from a remote control and to interrupt an operation of parking the motor vehicle, which has already started, after a predetermined interrupt command is received.

DE 92 11 012 U1 also discloses an antenna combination having an electrically conductive structure, on which a substantially resonant circuit is formed, and having at least two individual antennas which couple to its electrical field. The additional use of at least one further individual antenna, which couples to the magnetic field of the resonant circuit, results in further output from the resonant vehicle body circuit, with the result that the performance gain is substantially improved. Since the individual antenna which couples to the magnetic field of the resonant circuit outputs additional energy from the resonant circuit, the result is also greater attenuation of the resonant circuit, which, in addition to the performance gain, also increases the bandwidth of the entire antenna arrangement in a desirable manner.

### SUMMARY

In an embodiment, the present invention provides a Bluetooth control unit for a vehicle. The Bluetooth control unit includes a microcontroller; a transceiver connected to the microcontroller, the transceiver having an RF terminal for connection to an antenna; a plurality of antenna terminals; and a passive circuit. The passive circuit connects the RF terminal of the transceiver and the plurality of antenna terminals in a passive manner.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a schematic illustration of a receiving apparatus having a Bluetooth control unit and two antennas according to a first embodiment;

FIG. 2 shows a schematic illustration of a remotely controllable autonomous parking apparatus according to the first embodiment having the receiving apparatus from FIG. 1;

FIG. 3 shows an illustration of a slot patch antenna of the first embodiment in detail with additional diagrams of the antenna properties;

FIG. 4 shows a vehicle in a view from the front and from the rear in accordance with the first embodiment, the antennas being fitted to bumpers of the vehicle; and

FIG. 5 shows a detailed view of the front and rear bumpers with antennas fitted thereto.

### DETAILED DESCRIPTION

Embodiments of the invention provide one or more of the following: a Bluetooth control unit for a vehicle, a receiving apparatus for receiving Bluetooth signals for a vehicle, having such a Bluetooth control unit and a plurality of antennas, a remotely controllable autonomous parking apparatus having a control device for carrying out an autonomous parking operation and an above-mentioned receiving apparatus, and a vehicle having an above-mentioned receiving apparatus or an above-mentioned remotely controllable autonomous parking apparatus of the above-mentioned type, which can be used independently of a type of vehicle, achieve good field coverage around the vehicle, are independent of an orientation of a corresponding transmitter as far as possible and have a high level of acceptance during driving.

A Bluetooth control unit for a vehicle is contemplated herein, having a microcontroller and a transceiver connected to the microcontroller, the transceiver having a terminal for connection to an antenna, the Bluetooth control unit comprising a plurality of antenna terminals and a passive circuit, and the passive circuit connecting the terminal of the transceiver and the plurality of antenna terminals in a passive manner.

A receiving apparatus for receiving Bluetooth signals for a vehicle is also contemplated herein, having a Bluetooth control unit described above and a plurality of antennas, the antennas being connected to the antenna terminals of the control unit.

A remotely controllable autonomous parking apparatus is contemplated herein having a control device for carrying out an autonomous parking operation and an above-mentioned receiving apparatus which is connected to the control device.

A vehicle is contemplated herein having an above-mentioned receiving apparatus.

A vehicle is also contemplated herein having an above-mentioned remotely controllable autonomous parking apparatus.

Embodiments of the present invention contemplate connecting a plurality of antennas to the control unit via the passive circuit. This makes it possible to provide the receiving apparatus having a plurality of antennas which together enable good field coverage around the vehicle. This also results in many degrees of freedom when positioning the antennas in comparison with the roof antenna, with the result that there is no need to position the antennas on the vehicle roof. The control unit and the receiving system can therefore be installed directly in various vehicles (SUV, coupe, limousine, station wagon, convertible, Targa, etc.) without additional adaptations. In this case, the configuration of the control unit having the passive circuit is important in order to enable a plurality of antennas to be connected to the control unit. Bluetooth transceiver chips currently available on the market have only one terminal (RF I/O antenna). Therefore, it is not possible to directly connect two separate antennas directly to the transceiver/control unit. As a result of the passive interconnection, the control unit can have a simple structure and the two antenna terminals can be implemented without an additional energy consumption.

The antennas can be in the form of antennas for Bluetooth signals and can be optimized for the reception and transmission of signals in the 2.4 GHz ISM band.

The passive circuit is preferably arranged in the Bluetooth control unit. The passive circuit is particularly preferably arranged close to the transceiver. In principle, however, it is also possible for the passive circuit to be arranged outside the control unit, in which case greater power losses can occur here. If the passive circuit is arranged in the control unit, cable lengths of four to five meters or more are possible, in principle, between the Bluetooth control unit and the antennas.

The control device of the remotely controllable autonomous parking apparatus is designed to carry out an autonomous parking operation. This therefore comprises parking the vehicle in a parking space and removing the vehicle from a parking space. The Bluetooth control unit can be connected to the control device of the remotely controllable autonomous parking apparatus, for example, via a bus of the vehicle, for example an iCAN bus. The control device is designed to receive remote control signals via the Bluetooth control unit. The remote control signals are transmitted from a smartphone, for example. The remote control signals comprise “waking up” of the vehicle, starting of a parking operation and also control of the parking operation. In particular, the remote control signals comprise stopping or interruption of the parking operation. On the basis of this, the control device is designed to independently move the vehicle into a parking space or to move it out of a parking space.

In an advantageous configuration of the invention, the passive circuit comprises a Wilkinson splitter. The Wilkinson splitter is a power splitter which is used in RF technology. The Wilkinson splitter connects a first port to two second ports. It has only low power losses in this case. The function is based substantially on a λ/4 line transformation. During transmission, the power from a first port is equally divided between two second ports. If reflections occur on a signal path, the respective other signal path is not influenced. During reception, the Wilkinson splitter, as a power combiner, combines signals from the two second ports and outputs them at the first port. A differential-mode component between the second ports is destroyed in a shunt resistor.

In an advantageous configuration of the invention, the antennas are in the form of slot patch antennas. The slot patch antennas are usually circularly polarized and may provide a high antenna gain. The slot patch antennas make it possible to achieve an antenna gain of approximately up to 10 dBi. As a result, they can compensate for cable attenuations in antenna supply lines. Despite different possible attenuations in supply lines or in the passive circuit, for example, the antenna gain makes it possible to provide a purely passive system having good receiving properties. There is no need for a complicated active system having active amplifiers. As a result of the circular polarization, slot patch antennas are very independent of an orientation of a corresponding transmitter. The two slot patch antennas provide a robust receiving apparatus which enables reliable reception of emitted signals even in different holding positions of the transmitter, for example a smartphone. A good omnidirectional radiation characteristic can also be achieved. The slot patch antennas also have a flat structure which enables invisible fitting to the vehicle. The slot patch antennas are preferably optimized for receiving Bluetooth signals, in particular for receiving Bluetooth low energy signals at a frequency of 2.4 GHz.

In an advantageous configuration of the invention, the antennas are in the form of waterproof antennas. As a result, they can also be fitted in vehicle regions outside a passenger compartment where they are exposed to weather influences.

In an advantageous configuration of the invention, a respective antenna is arranged at a front end of the vehicle and at a rear end of the vehicle. This makes it possible to achieve great field coverage with two antennas, the field coverage being uniformly achieved around the entire vehicle. In particular, an improved range can be achieved in the front vehicle region by means of the antenna fitted there. In comparison with a roof antenna which is fitted in a rear region of the vehicle, the improved range may be up to four meters or more.

In an advantageous configuration of the invention, the antenna at the front end of the vehicle is arranged on a front bumper of the vehicle, in particular on the left-hand side, and the antenna at the rear end of the vehicle is arranged on a rear bumper of the vehicle, in particular on the right-hand side, each based on a direction of travel of the vehicle. The arrangement on the bumper is particularly advantageous since the bumper usually defines a front end and a rear end of the vehicle, thus making it possible to achieve good field coverage. The antennas are particularly preferably positioned under the corresponding bumpers, with the result that they can be mounted in a manner protected from weather influences. In addition, the antennas may be mounted invisibly there. Since bumpers are nowadays usually produced from plastic, the antennas can be mounted under the bumpers without any additional antenna losses. An additional increase in the field coverage can be achieved by means of the preferred arrangement at the front right and rear left or vice versa.

In the present case, the control unit and the receiving apparatus have been described, in particular, with reference to the reception of Bluetooth signals for performing an autonomous parking operation. It goes without saying that the same advantages also arise in other applications based on the use of Bluetooth-based remote controls. This relates, for example, to remote control of a central locking system, keyless entry, personalization of vehicle settings during the approach of a driver who can be identified via a Bluetooth unit, or the like. The personalization of vehicle settings relates, for example, to settings for a seat position, a preferred vehicle temperature, illumination of fittings or an interior of the vehicle, settings for a multimedia system, or the like.

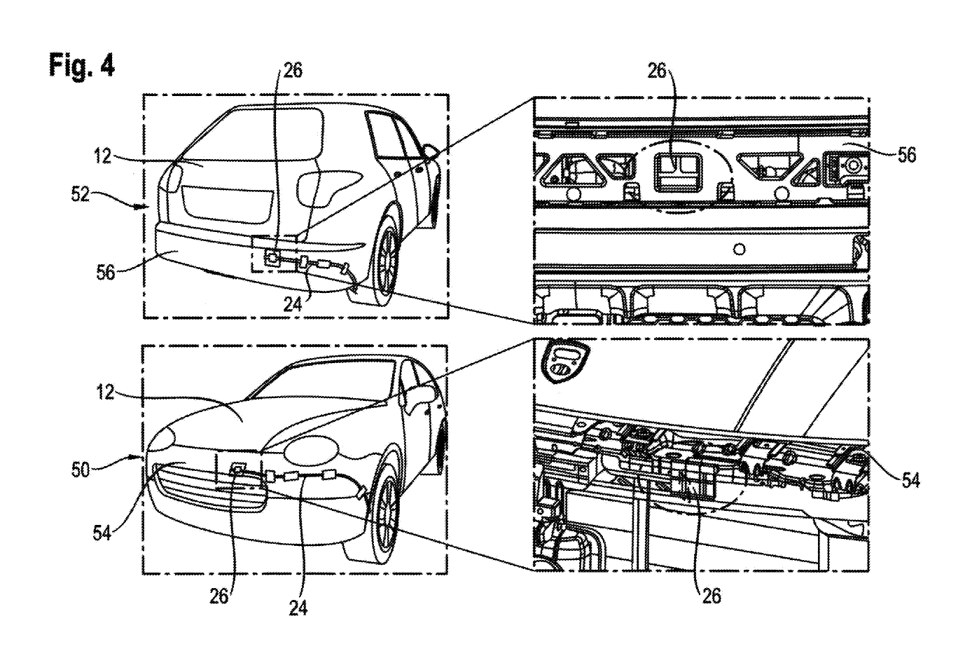

FIG. 1 shows a Bluetooth control unit 10 according to the invention according to a first embodiment. The Bluetooth control unit 10 is designed for use in a vehicle 12, which is illustrated in FIG. 4 for example, and is fitted in the vehicle 12 in a manner not illustrated in detail.

The Bluetooth control unit 10 comprises a microcontroller 14 and a transceiver 16 connected to the microcontroller 14. The transceiver 16 has an RF terminal 18 for receiving and transmitting RF signals. The Bluetooth control unit 10 comprises a plurality of antenna terminals 20 which are connected to the terminal 18 of the transceiver 16 in a passive manner via a passive circuit 22.

The passive circuit 22 is in the form of a Wilkinson splitter. In this exemplary embodiment, the passive circuit 22 is arranged close to the transceiver 16 and is connected to the latter via a short RF line 24.

A circuit board 28 is also arranged in the Bluetooth control unit 10 as a host PCB. Various functions of the Bluetooth control unit are implemented thereon, for example for integration in the vehicle 12.

As is also illustrated in FIG. 1, the Bluetooth control unit 10 is part of a receiving apparatus 30 for receiving Bluetooth signals. The receiving apparatus 30 is likewise designed for use in the vehicle 12 and comprises two antennas 26 in addition to the Bluetooth control unit 10, the antennas 26 being connected to the antenna terminals 20 of the Bluetooth control unit 10 via RF lines 24.

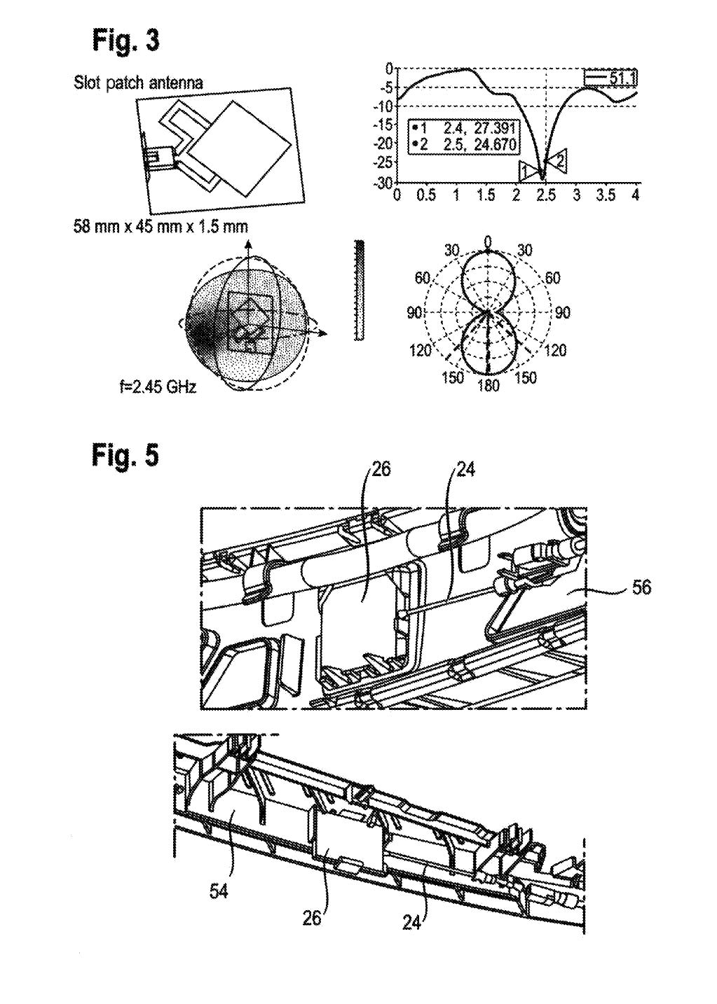

The antennas 26 are in the form of antennas for Bluetooth signals and are optimized for the reception and transmission of signals in the 2.4 GHz ISM band, in particular for Bluetooth low energy signals. In detail, the antennas 26 are in the form of waterproof slot patch antennas which are circularly polarized and provide a high antenna gain. The slot patch antenna 26 of the first embodiment is shown in detail in FIG. 3, additional diagrams containing the antenna properties of the slot patch antenna 26 shown being indicated in FIG. 3. As is clear there, the slot patch antenna 26 has a flat structure and has a good omnidirectional radiation characteristic.

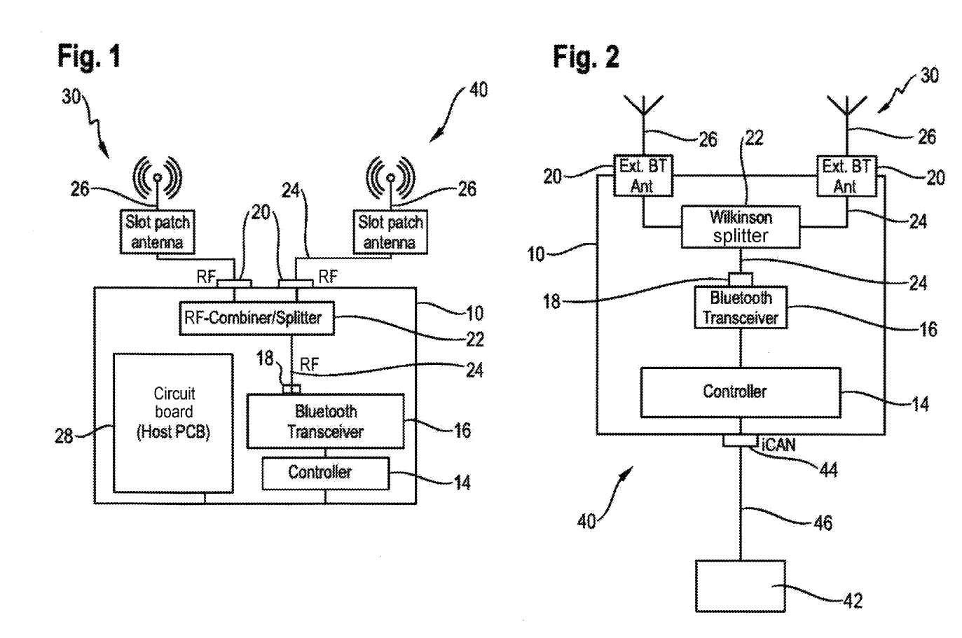

FIG. 2 shows a remotely controllable autonomous parking apparatus 40 in accordance with the first embodiment. The remotely controllable autonomous parking apparatus 40 comprises the receiving apparatus 30 from FIG. 1 and a control device 42 for carrying out an autonomous parking operation. The Bluetooth control unit 10 has a bus terminal 44 which is designed for connection to an iCAN bus 46. The bus terminal 44 of the Bluetooth control unit 10 is connected to the iCAN bus 46 of the vehicle 12, with the result that the control device 42 is connected to the Bluetooth control unit 10 via the iCAN bus 46.

The control device 42 is designed to autonomously park the vehicle 12. Accordingly, the control device 42 is designed to receive remote control signals via the Bluetooth control unit 10. The remote control signals are transmitted from a smartphone, for example. The remote control signals comprise “waking up” of the vehicle 12, starting of a parking operation and also control of the parking operation. In particular, the remote control signals comprise stopping or interruption of the parking operation. On the basis of this, the control device 42 is designed to independently move the vehicle 12 into a parking space or to move it out of a parking space.

The vehicle 12 in accordance with the first embodiment is illustrated in detail in FIG. 4. The vehicle 12 comprises the remotely controllable autonomous parking apparatus 40 of the first embodiment, only the antennas 26 of the remotely controllable autonomous parking apparatus 40 being illustrated in FIG. 4.

In this exemplary embodiment, the antennas 26 are arranged at a front end 50 of the vehicle 12 and at a rear end 52 of the vehicle 12. For this purpose, the antenna 26 at the front end 50 of the vehicle 12 is arranged on a front bumper 54 of the vehicle 12, specifically on the left-hand side based on a direction of travel. The antenna 26 at the rear end 52 of the vehicle 12 is arranged on a rear bumper 56 of the vehicle 12, specifically on the right-hand side based on a direction of travel. For better visibility, the antennas 26 are illustrated on the outside of the corresponding bumpers 54, 56 in FIG. 4. However, the antennas 26 according to the first embodiment are positioned below the corresponding bumpers 54, 56, as is illustrated in detail in FIG. 5, as a result of which the antennas 26 are invisibly fitted to the vehicle 12. The bumpers 54, 56 are produced from plastic or carbon.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

| | |
|---|---|
| Bluetooth control unit | 10 |
| Vehicle | 12 |
| Microcontroller | 14 |
| Transceiver | 16 |
| RF terminal | 18 |
| Antenna terminal | 20 |
| Passive circuit | 22 |
| RF cable | 24 |
| Antenna | 26 |
| Circuit board, host PCB | 28 |
| Receiving apparatus | 30 |
| Parking apparatus | 40 |
| Control device | 42 |
| Bus terminal | 44 |
| iCAN bus | 46 |
| Front end | 50 |
| Rear end | 52 |
| Front bumper | 54 |
| Rear bumper | 56 |

What is claimed is:

1. A Bluetooth control unit for a vehicle, the Bluetooth control unit comprising:
a microcontroller;
a transceiver connected to the microcontroller, the transceiver having an RF terminal for connection to an antenna;
a plurality of antenna terminals; and
a passive circuit,
wherein the passive circuit connects the RF terminal of the transceiver and the plurality of antenna terminals in a passive manner.

2. The Bluetooth control unit as claimed in claim 1, wherein the passive circuit comprises a Wilkinson splitter.

3. A receiving apparatus for receiving Bluetooth signals for a vehicle, comprising:
a Bluetooth control unit comprising:
a microcontroller;
a transceiver connected to the microcontroller, the transceiver having an RF terminal for connection to an antenna;
a plurality of antenna terminals; and
a passive circuit; and
a plurality of antennas,
wherein the passive circuit connects the RF terminal of the transceiver and the plurality of antenna terminals in a passive manner, and
wherein the antennas are connected to the antenna terminals of the control unit.

4. The receiving apparatus as claimed in claim 3, wherein the antennas are slot patch antennas.

5. The receiving apparatus as claimed in claim 3, wherein the antennas are waterproof antennas.

6. A remotely controllable autonomous parking apparatus comprising:
a control device for carrying out an autonomous parking operation; and
a receiving apparatus comprising:
a Bluetooth control unit comprising:
a microcontroller;
a transceiver connected to the microcontroller, the transceiver having an RF terminal for connection to an antenna;
a plurality of antenna terminals; and
a passive circuit; and
a plurality of antennas,
wherein the passive circuit connects the RF terminal of the transceiver and the plurality of antenna terminals in a passive manner, and
wherein the antennas are connected to the antenna terminals of the control unit
wherein the receiving apparatus is connected to the control device.

7. A vehicle having a receiving apparatus as claimed in claim 3.

8. The vehicle as claimed in claim 7, wherein the receiving apparatus has two antennas, and wherein a first of the two antennas is arranged at a front end of the vehicle and a second of the two antennas is arranged at a rear end of the vehicle.

9. The vehicle as claimed in claim 8, wherein the first antenna at the front end of the vehicle is arranged on a front bumper of the vehicle on a left-hand side, and the second antenna at the rear end of the vehicle is arranged on a rear bumper of the vehicle on a right-hand side, each of the left-hand side and the right-hand side being based on a direction of travel of the vehicle.

10. A vehicle having a remotely controllable autonomous parking apparatus as claimed in claim 6.
